(19) United States
(12) Patent Application Publication
(10) Pub. No.: US 2026/0281037 A1
(43) Pub. Date: Sep. 17, 2026

(54) Network traffic rerouting for power reduction

(71) Applicant: Mellanox Technologies, Ltd., Yokneam (IL)

(72) Inventors: Nir Sucher, Ramat Hashofet (IL); Amit Kazimirsky, Givat Shmuel (IL)

(21) Appl. No.: 19/081,023

(22) Filed: Mar. 17, 2025

(51) Int. Cl. H04L 45/851; H04L 45/60; H04L 45/74

(52) U.S. Cl. CPC H04L 45/851; H04L 45/60; H04L 45/74

(57) ABSTRACT

In one embodiment, a system for managing power consumption in a node interconnect network includes a plurality of nodes interconnected via a network, and an orchestrator to analyze link requirements, configure dynamic routing profiles for the plurality of nodes based on the link requirements, and instruct the plurality of nodes to implement the dynamic routing profiles, wherein each one node of the plurality of nodes is to selectively route traffic to a subset of available ports of the one node based on a dynamic routing profile of the one node, thereby allowing unused ports to enter a low-power state.

### FIELD OF DISCLOSURE

The present disclosure relates to computer systems, and more particularly but not exclusively to, power management.

### BACKGROUND

Graphics processing units (GPUs) are widely used in modern computing systems for various applications, including graphics rendering, scientific simulations, and machine learning. These GPUs are often interconnected in high-performance computing environments to enable parallel processing and data sharing across multiple devices.

GPU interconnect networks facilitate communication between multiple GPUs and other components within a system. These networks typically employ high-bandwidth, low-latency links to transfer data efficiently between devices. Common interconnect technologies include NVLink, PCIe, and InfiniBand, each offering different performance characteristics and capabilities.

Power consumption is a consideration in GPU interconnect networks, particularly in large-scale computing environments. The energy used by these networks can contribute significantly to the overall power usage of a system. As such, there is interest in developing techniques to manage and reduce power consumption in GPU interconnect networks.

Advancements in GPU interconnect technologies continue to focus on improving performance, efficiency, and scalability. These developments aim to support the growing demands of complex computational tasks while addressing considerations such as power consumption and system integration.

### Overview

There is provided in accordance with an embodiment of the present disclosure, a system for managing power consumption in a node interconnect network, comprising a plurality of nodes interconnected via a network, and an orchestrator to analyze link requirements, configure dynamic routing profiles for the plurality of nodes based on the link requirements, and instruct the plurality of nodes to implement the dynamic routing profiles, wherein each one node of the plurality of nodes is to selectively route traffic to a subset of available ports of the one node based on a dynamic routing profile of the one node, thereby allowing unused ports to enter a low-power state.

Further in accordance with an embodiment of the present disclosure, the orchestrator is to monitor network traffic and adjust the dynamic routing profiles in real-time based on changes in the monitored network traffic.

Still further in accordance with an embodiment of the present disclosure, the low-power state is an L1 state.

Additionally in accordance with an embodiment of the present disclosure, each one node comprises a routing device to implement the dynamic routing profile for the one node.

Moreover, in accordance with an embodiment of the present disclosure, the routing device is to route traffic defined as critical traffic to the available ports and traffic defined as non-critical traffic to the subset of the available ports.

Further in accordance with an embodiment of the present disclosure, the orchestrator is to reallocate power saved from unused ports entering the low-power state to node computing resources.

Still further in accordance with an embodiment of the present disclosure, the node is a graphics processing unit (GPU) or a central processing unit (CPU).

There is provided in accordance with another embodiment of the present disclosure, an orchestrator for managing power consumption in a node interconnect network, comprising a processor to analyze link requirements in a network interconnecting a plurality of nodes, configure dynamic routing profiles for the plurality of nodes based on the link requirements, and instruct the plurality of nodes to implement the dynamic routing profiles, wherein the dynamic routing profiles cause each node to selectively route traffic to a subset of available ports, thereby allowing unused ports to enter a low-power state, and an interface to share data with the nodes.

Further in accordance with an embodiment of the present disclosure, the processor is to monitor network traffic and adjust the dynamic routing profiles in real-time based on changes in the monitored network traffic.

Still further in accordance with an embodiment of the present disclosure, the low-power state is an L1 state.

Additionally in accordance with an embodiment of the present disclosure, the processor is to instruct each node to route traffic defined as critical traffic to all the available ports and traffic defined as non-critical traffic to the subset of the available ports.

Moreover, in accordance with an embodiment of the present disclosure, the processor is to reallocate power saved from unused ports entering the low-power state to node compute resources.

Further in accordance with an embodiment of the present disclosure, the node is a graphics processing unit (GPU) or a central processing unit (CPU).

There is also provided in accordance with still another embodiment of the present disclosure, a node device, comprising a plurality of ports to connect to links of a network, a routing device to route network traffic to the plurality of ports, and a processor to configure the routing device to selectively route traffic to a subset of the plurality of ports, thereby allowing unused ports to enter a low-power state.

Further in accordance with an embodiment of the present disclosure, the processor is to receive a dynamic routing profile from an orchestrator.

Still further in accordance with an embodiment of the present disclosure, the processor is to configure the routing device based on the received dynamic routing profile.

Additionally in accordance with an embodiment of the present disclosure, the low-power state is an L1 state.

Moreover, in accordance with an embodiment of the present disclosure, the routing device is to route traffic defined as critical traffic to all of the plurality of ports and traffic defined as non-critical traffic to the subset of the plurality of ports.

Further in accordance with an embodiment of the present disclosure, the processor is to monitor network traffic on the plurality of ports, and send network traffic data to an orchestrator.

Further in accordance with an embodiment of the present disclosure, the processor is to receive an updated dynamic routing profile from the orchestrator based on the sent network traffic data.

Still further in accordance with an embodiment of the present disclosure, the processor is to reconfigure the routing device based on the updated dynamic routing profile to adjust the subset of the plurality of ports to which traffic is selectively routed.

Additionally in accordance with an embodiment of the present disclosure, the node device is a graphics processing unit (GPU) or a central processing unit (CPU).

There is also provided in accordance with still another embodiment of the present disclosure, a method for managing power consumption in a node interconnect network, comprising analyzing link requirements in a network interconnecting a plurality of nodes, configuring dynamic routing profiles for the plurality of nodes based on the link requirements, and instructing the plurality of nodes to implement the dynamic routing profiles, wherein each one node of the plurality of nodes selectively routes traffic to a subset of available ports of the one node based on a dynamic routing profile of the one node, thereby allowing unused ports to enter a low-power state.

There is also provided in accordance with still another embodiment of the present disclosure, a method for managing power consumption in a node interconnect network, comprising analyzing link requirements in a network interconnecting a plurality of nodes, configuring dynamic routing profiles for the plurality of nodes based on the link requirements, and instructing the plurality of nodes to implement the dynamic routing profiles, wherein the dynamic routing profiles cause each node to selectively route traffic to a subset of available ports, thereby allowing unused ports to enter a low-power state.

There is also provided in accordance with still another embodiment of the present disclosure, a method for managing power consumption in a node device, comprising connecting a plurality of ports to links of a network, routing network traffic to the plurality of ports, and configuring a routing device to selectively route traffic to a subset of the plurality of ports, thereby allowing unused ports to enter a low-power state.

### BRIEF DESCRIPTION OF THE DRAWINGS

The present disclosure will be understood from the following detailed description, taken in conjunction with the drawings in which:

FIG. 1 is a simplified pictorial illustration of a computer system constructed and operative in accordance with an embodiment of the present disclosure;

FIG. 2 is a more detailed view of a network orchestrator in the system of FIG. 1;

FIG. 3 is a flowchart including steps in a method of operation of the network orchestrator of FIG. 2;

FIG. 4 is a more detailed view of a processing node in the system of FIG. 1;

FIG. 5 is a flowchart including steps in a method of operation of the processing node of FIG. 4;

FIG. 6 is a port power graph illustrating a configuration where all ports are active;

FIG. 7 is a port power graph illustrating a configuration where a subset of ports are active; and

FIG. 8 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview Of Example Embodiments

Graphics processing unit (GPU) interconnect networks consume significant power, particularly when links remain active during idle periods. Existing power management techniques face several challenges in addressing this issue effectively. Short idle intervals, which are common in many workloads, are often too brief to justify entering a low-power state due to the exit latency associated with returning to an active state.

For example, a reduced bandwidth mode (RBM) implementation may require a minimum idle period before transitioning to a low-power state such as L1. The L1 state typically involves powering down certain components of the link, which can result in significant power savings. However, exiting the L1 state and returning to full operational capacity may incur a latency penalty. In some cases, the exit latency from L1 state may range from microseconds to milliseconds, depending on the specific hardware implementation. This exit latency may include time for powering up components, re-establishing link synchronization, and reconfiguring the link for full-bandwidth operation. To balance power savings with performance, the system may implement a threshold idle time before entering L1 state. This threshold may be dynamically adjusted based on workload characteristics and system requirements. For example, if the idle period is shorter than the threshold, the link may remain in a higher power state to avoid frequent transitions and associated latency penalties.

In some cases, the threshold idle time approach may lead to links rarely or never entering the L1 state during certain time periods. This situation may occur when workload patterns or system conditions prevent idle periods from consistently exceeding the set threshold. For example, in systems with multiple interconnected GPUs or other processing nodes, coordinated workloads may result in staggered communication patterns. This staggering may cause links to experience frequent, short idle periods as different nodes take turns transmitting data. If these idle periods are shorter than the threshold, the links may remain in higher power states despite having cumulative idle time that could benefit from entering L1 state.

One possible solution is to implement a system-wide power management scheme that shuts down unused links or ports. However, this approach has drawbacks, including the need for synchronized reconfiguration across all GPUs, which can lead to system downtime and performance degradation.

Embodiments of the present disclosure address at least some of the above drawbacks by providing a system and method that implements intelligent traffic rerouting within processing nodes (e.g., GPUs) allowing unused ports to enter a low-power state automatically thereby managing power consumption more effectively in interconnect networks.

In some embodiments, the system comprises an orchestrator that analyzes link requirements and configures dynamic routing profiles for a plurality of interconnected processing nodes. These profiles instruct each node to selectively route traffic to a subset of available ports, allowing unused ports to enter a low-power state automatically. This approach enables fine-grained control over network power consumption while maintaining system flexibility and responsiveness.

For example, the system may route traffic to half of the available ports while allowing the other half to enter a low-power state automatically. For example, consider a processing node with eight communication ports. The orchestrator may configure a dynamic routing profile that instructs the node to utilize only ports 1, 2, 3, and 4 for active traffic, while ports 5, 6, 7, and 8 may remain unused. When this routing profile is implemented, the routing device within the processing node may direct all outgoing network traffic through ports 1-4. These active ports may operate at full capacity, handling various types of data transfers, including critical and non-critical traffic. Meanwhile, ports 5-8 may detect a lack of traffic and automatically transition into the L1 low-power state.

In some cases, the routing device within each node is configured to route critical traffic to all available ports while confining non-critical traffic to a subset of ports. This ensures that essential communications are not impacted while still allowing for power savings on less critical data transfers.

The system may also include real-time monitoring and adjustment of routing profiles based on changes in network traffic. This dynamic approach allows the system to adapt to varying workload demands and optimize power consumption continuously.

Advantages of this solution include the ability to achieve significant power savings without the drawbacks associated with traditional reduced bandwidth mode implementations. By allowing individual processing nodes (e.g., GPUs) to transition to new routing configurations independently, the system avoids the need for disruptive system-wide synchronization.

Embodiments of the present disclosure improve the way a computer or other processing device works by providing better computer performance, reducing power consumption, and potentially increasing data access speed. By optimizing the use of interconnect links and allowing unused ports to enter low-power states, the system can reallocate power savings to processing node (e.g., GPU) compute resources, potentially improving overall system performance in power-constrained scenarios.

### System Description

In the context of this disclosure, a “processing node” may refer to a computational unit capable of executing instructions and processing data. In some cases, a processing node may be a graphics processing unit (GPU) or a central processing unit (CPU). A processing node may be interconnected with other processing nodes through a network architecture.

A “network link” may refer to a communication pathway that connects a processing node or network switch or other network infrastructure component to one or more other processing nodes, and/or to network switch(s) and/or to other network infrastructure component(s). Network links may facilitate data transfer between processing nodes and other elements of the network.

A “routing profile” may refer to a set of instructions or parameters that define how network traffic should be directed through available communication ports of a processing node. In some cases, a routing profile may specify which subset of available ports should be used for routing traffic, and for which class of traffic (e.g., non-essential or essential).

A “low-power state” may refer to an operational mode of a network link or port where power consumption is reduced compared to a fully active state. In some cases, the low-power state may be an L1 state. The L1 state may allow for faster reactivation compared to a fully powered-down state while still providing significant power savings. However, any suitable low power state may be used instead of L1 state.

A “routing device” may refer to a component within a processing node that manages the routing of network traffic through the node's communication ports. In some cases, the routing device may be referred to as an HSHUB (High-Speed Hub). The routing device may implement routing profiles to control traffic flow through the processing node.

A “node interconnect network” may refer to a communication infrastructure that facilitates data exchange between multiple processing nodes in a computing system. This network may comprise various components such as network links, switches, and communication ports, which collectively enable data transfer between nodes (e.g., high-speed, low-latency data transfer between nodes). In some cases, a node interconnect network may support different topologies and protocols to optimize performance for specific computational tasks or system architectures.

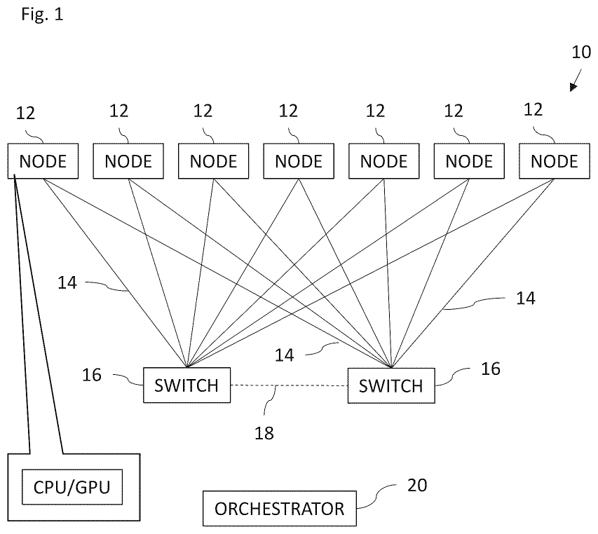

Reference is now made to FIG. 1, which is a simplified pictorial illustration of a computer system 10. The computer system 10 may include a plurality of processing nodes 12 interconnected via a network. The network may comprise network links 14, network switches 16, and switch interconnects 18.

In some cases, the processing nodes 12 may be connected to the network switches 16 through the network links 14. The network switches 16 may be connected to each other via the switch interconnects 18. This configuration may allow the processing nodes 12 to communicate with each other through multiple paths in the network.

The computer system 10 may also include a network orchestrator 20. The network orchestrator 20 may manage network operations and power consumption within the computer system 10.

In some cases, the network orchestrator 20 may determine link requirements based on factors such as network traffic, power consumption, and performance requirements like latency. The network orchestrator 20 may use these link requirements to configure routing profiles for the processing nodes 12.

The network switches 16 may play a role in power saving within the computer system 10. When certain network links 14 are not used due to the routing profiles implemented by the processing nodes 12, the corresponding ports on the network switches 16 may enter a low-power state. This may result in power savings not only on the processing nodes 12 but also on the network switches 16.

In some cases, when all ports on a network switch 16 are unused due to the routing profiles implemented by the processing nodes 12, the entire network switch 16 may enter a power-saving mode. This may occur when traffic patterns allow for consolidation of active connections onto fewer switches, enabling some switches to become completely idle. The power-saving mode for an entire switch may involve powering down non-essential components, reducing clock speeds, or utilizing other power management techniques. This approach may lead to even greater energy savings across the computer system 10, as entire switching units may operate at significantly reduced power levels during periods of low network utilization.

In some cases, the processing nodes 12 may include graphics processing units (GPUs) and/or central processing units (CPUs). The network orchestrator 20 may manage the routing of data traffic between these processing nodes 12 to optimize performance and power consumption across the computer system 10.

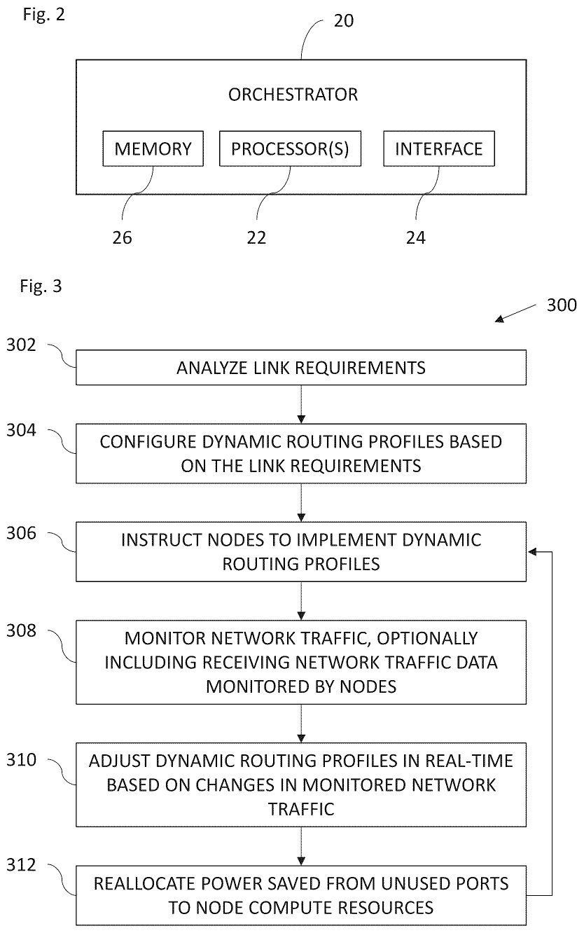

Reference is now made to FIGS. 2 and 3, which are a block diagram view of network orchestrator 20 and a flowchart including steps in a method 300, respectively.

Network orchestrator 20 may comprise processor(s) 22, an interface 24, and memory 26. The processor(s) 22 may be configured to analyze link requirements in a network interconnecting a plurality of nodes. Based on the analyzed link requirements, the processor(s) 22 may configure dynamic routing profiles for the plurality of nodes. The interface 24 may be used to share data with the nodes, including instructions to implement the dynamic routing profiles.

In some cases, the network orchestrator may determine link requirements through a multi-faceted analysis of network conditions and performance metrics. For example, the orchestrator may monitor real-time network traffic patterns, analyzing factors such as data transfer rates, packet sizes, and communication frequencies between specific node pairs. The orchestrator may also consider historical usage data to identify recurring patterns or trends in network utilization.

Additionally, the orchestrator may take into account power consumption data from individual ports and links, as well as overall system power usage. This information may be combined with performance requirements, such as maximum allowable latency for certain types of traffic or minimum bandwidth guarantees for critical applications.

Based on this comprehensive analysis, the orchestrator may identify opportunities for power optimization without compromising essential network performance. For instance, if the analysis reveals that certain node pairs consistently exchange large volumes of data while others communicate infrequently, this information may be used to shape the dynamic routing profiles.

Translating these link requirements into dynamic routing profiles may involve several steps. The orchestrator may first categorize traffic types based on their priority and performance needs. It may then determine the minimum number of active ports required to handle the current and anticipated network load while meeting performance targets.

For example, if the link requirement analysis indicates that a processing node typically utilizes only 60% of its available bandwidth, the orchestrator may generate a dynamic routing profile that activates only three out of four available ports. This profile may instruct the node's routing device to direct all traffic through ports 1, 2, and 3, while allowing port 4 to enter a low-power state.

The dynamic routing profile may also include rules for traffic prioritization. For instance, it may specify that high-priority, latency-sensitive traffic should be distributed across all active ports to minimize congestion, while lower-priority bulk data transfers may be confined to a subset of the active ports.

In some implementations, the orchestrator may create multiple routing profiles for each node, each optimized for different network conditions or time periods. The node may then switch between these profiles based on real-time instructions from the orchestrator or predefined triggers, allowing for adaptive power management that responds to changing network demands.

In some cases, the processor(s) 22 may monitor network traffic and adjust the dynamic routing profiles in real-time based on changes in the monitored network traffic. The dynamic routing profiles may cause nodes to selectively route traffic to a subset of available ports, thereby allowing unused ports to enter a low-power state. In some implementations, the processor(s) 22 may instruct each node to route traffic defined as critical traffic to all available ports and traffic defined as non-critical traffic to the subset of available ports.

The network orchestrator 20 may execute method 300 for managing power consumption in a node interconnect network. One or more of the steps of method 300 may be performed by the processor(s) 22 of orchestrator 20 being configured to perform the steps. The steps of method 300 may be performed in any suitable order.

The method 300 may begin at step 302 with analyzing link requirements. At step 304, the method 300 may configure dynamic routing profiles based on the link requirements. The method 300 may then proceed to step 306, where nodes 12 are instructed to implement dynamic routing profiles.

At step 308, the method 300 may monitor network traffic, which can include receiving network traffic data monitored by nodes 12. The method 300 may continue to step 310, where dynamic routing profiles are adjusted in real-time based on changes in monitored network traffic.

In some implementations, at step 312, the method 300 may reallocate power saved from unused ports entering the low-power state to node compute resources. After step 312, the method 300 may return to step 306 to continue the process.

By configuring and adjusting dynamic routing profiles, the network orchestrator 20 may manage power consumption in the node interconnect network while maintaining efficient network operation.

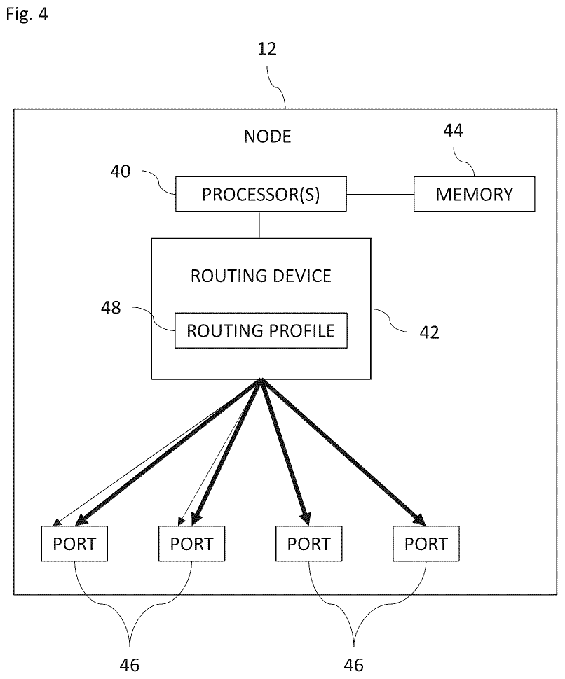

Reference is now made to FIG. 4, which is a block diagram of a processing node 12. A processing node 12 may comprise processor(s) 40, a routing device 42, memory 44, and communication ports 46. In some cases, the processing node 12 may be a graphics processing unit (GPU) or a central processing unit (CPU).

The processor(s) 40 may be connected to both the routing device 42 and the memory 44. The routing device 42 may contain a routing profile 48 and may be connected to multiple communication ports 46. The communication ports 46 may provide interfaces for connecting the processing node 12 to network links.

The routing device 42 may manage the routing of network traffic from the processor(s) 40 through the communication ports 46 based on the routing profile 48. In some cases, the routing device 42 may selectively route traffic to different communication ports 46 according to the routing profile 48 stored within the routing device 42.

The memory 44 may be connected to the processor(s) 40 and may store data and instructions used by the processor(s) 40. In some cases, the memory 44 may store the routing profile 48 or other data related to network traffic management.

The communication ports 46 may connect the processing node 12 to links of a network. In some cases, the number and configuration of communication ports 46 may vary depending on the specific requirements of the network architecture.

The routing profile 48 within the routing device 42 may contain instructions or parameters for managing network traffic. In some cases, the routing profile 48 may be dynamically updated based on network conditions or instructions from network orchestrator 20.

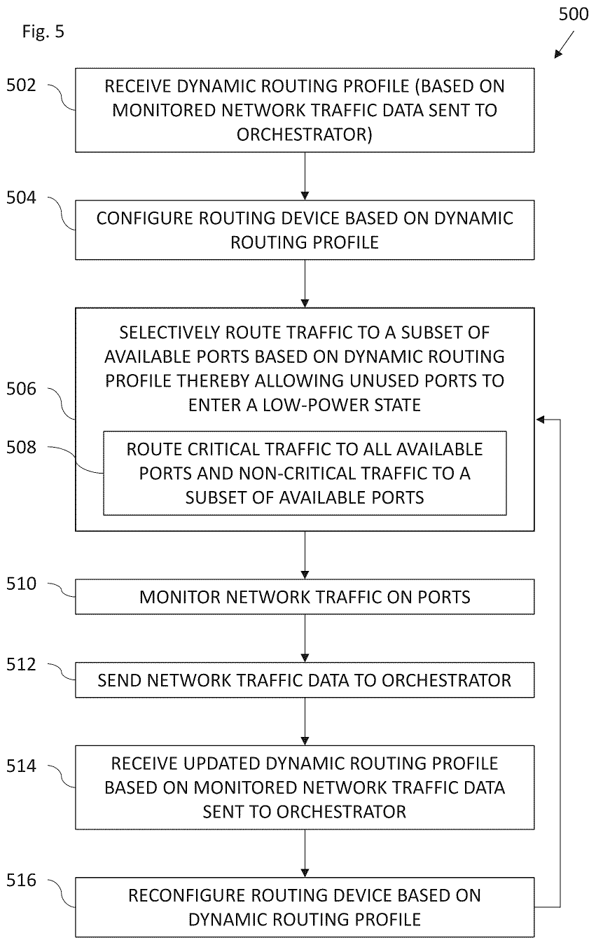

Reference is now made to FIG. 5, which is a flowchart illustrating a method 500 for managing power consumption in processing node 12. The method 500 may include several steps for implementing dynamic routing profiles and selectively routing network traffic. One or more of the steps of method 500 may be performed by the processor(s) 40 of node 12 being configured to perform the steps. The steps of method 500 may be performed in any suitable order.

In some cases, the method 500 may begin with a step 502 of receiving dynamic routing profile 48. The processor(s) 40 of the processing node 12 may receive the dynamic routing profile 48 from orchestrator 20. The dynamic routing profile 48 may be generated based on monitored network traffic data previously sent to the orchestrator 20.

The method 500 may proceed to a step 504 of configuring routing device 42. The processor 40 may configure the routing device 42 based on the received dynamic routing profile 48. This configuration may determine how network traffic is routed through the processing node's communication ports 46.

A step 506 of the method 500 may involve the routing device 42 selectively routing traffic to a subset of available ports 46 based on the dynamic routing profile 48. This selective routing may allow unused ports 46 to enter a low-power state, such as an L1 state (e.g., after a given timeout of no traffic on each port 46). In some cases, as shown in step 508, the routing device 42 may route traffic defined as critical traffic to all available ports 46 and traffic defined as non-critical traffic to the subset of available ports 46. In some cases, the critical traffic may be routed to a larger subset of available ports than the non-critical traffic. Traffic may be defined as critical or non-critical based on indications provided in headers of the packets of the traffic, for example, using QoS data.

The routing profile 48 instructs the routing device 42 how to route traffic out of a node 12 via some of the ports 46 of the node 12 while a subset of ports 46 are allowed to become idle and enter, and remain in, L1 state. However, if other nodes 12 are not configured correctly, the subset of ports 46 may not remain idle as desired and may not enter, and remain in, L1 state. Specifically, the subset of ports should be unused for both transmitting and receiving traffic to enter, and remain in, the L1 state.

To achieve this, the orchestrator 20 may configure the routing profiles of other nodes 12 to avoid sending traffic to the ports intended to enter the L1 state. This coordinated approach may ensure that a port is unused in both directions-for transmitting from its own node and for receiving from other nodes.

In some cases, the routing profiles of each node 12 may be generated with consideration for this two-way nature of the ports. The orchestrator 20 may analyze the network topology and traffic patterns to identify opportunities where specific ports on multiple nodes can be simultaneously unused for both transmit and receive operations.

For example, if the orchestrator 20 determines that a particular port on node A can enter L1, it may not only configure node A's routing profile to avoid sending traffic through that port, but also adjust the routing profiles of other nodes that might typically send traffic to that port on node A. This coordinated configuration may allow the port to remain inactive and enter the L1 state.

In some implementations, the orchestrator 20 may use a holistic approach when generating routing profiles, considering the potential L1 state opportunities across the entire network. This may involve balancing the desire for power savings through L1 state entry with the need to maintain sufficient active connections for network performance and redundancy.

The dynamic nature of the routing profiles may allow for adaptive management of these two-way port considerations. As network conditions change, the orchestrator 20 may adjust routing profiles across multiple nodes to create new opportunities for ports to enter L1 or to reactivate ports as needed to handle increased traffic demands.

The method 500 may include a step 510 of monitoring network traffic on the ports 46. The processor 40 may monitor the network traffic to gather data on current usage patterns and performance. This monitoring may be followed by a step 512 of sending network traffic data to the orchestrator 20. The processor 40 may send this data to inform the orchestrator of the current network conditions at the processing node 12.

In some cases, the method 500 may include a step 514 of receiving an updated dynamic routing profile 48. The processor 40 may receive this updated profile from the orchestrator 20 based on the sent network traffic data. This updated profile 48 may reflect changes in network conditions or requirements.

The method 500 may conclude with a step 516 of reconfiguring the routing device 42. The processor 40 may reconfigure the routing device 42 based on the updated dynamic routing profile 48. This reconfiguration may adjust the subset of ports 46 to which traffic is selectively routed, potentially changing which ports 46 enter or exit the low-power state.

After step 516, the method 500 may return to step 506 to continue selectively routing traffic according to the reconfigured routing profile 48. This cycle of monitoring, updating, and reconfiguring may allow the processing node 12 to adapt its routing behavior to changing network conditions and requirements, potentially optimizing power consumption and performance over time.

In some implementations, the system may handle unexpected traffic on ports intended to be in a low-power state. While the routing device 42 may be configured to route traffic to a specific subset of ports 46 based on the current routing profile 48, the remaining ports may still be capable of receiving packets. If a port 46 that is not part of the active subset receives traffic, it may automatically transition from the low-power state (such as L1) to an active state to process the incoming packets.

This behavior may occur in various scenarios, such as when there is a delay in other nodes implementing updated routing profiles, or in cases of routing errors. The system may be designed to maintain network reliability by ensuring that no packets are dropped due to ports being in a low-power state.

When a port 46 in a low-power state receives traffic, it may quickly exit the L1 state and become fully operational to handle the incoming data. After processing the received packets, the port may then wait for a predetermined period of inactivity before transitioning back to the L1 state.

The routing device 42 may be notified when a port exits the L1 state due to unexpected traffic. In some cases, this information may be used to temporarily adjust the routing behavior or to inform the orchestrator 20 of potential misalignments in routing profiles across the network. The orchestrator 20 may use this data to refine its routing profile configurations and improve the coordination of power management strategies across multiple nodes.

By allowing ports to dynamically respond to incoming traffic, even when they are intended to be in a low-power state, the system may maintain network flexibility and resilience while still pursuing overall power optimization goals. This approach may help to prevent data loss and ensure that the network can adapt to unexpected traffic patterns or temporary inconsistencies in routing configurations across different nodes.

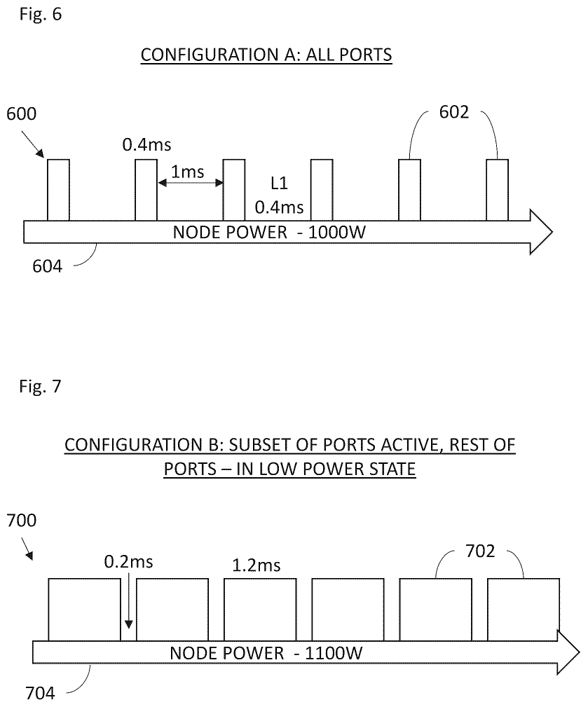

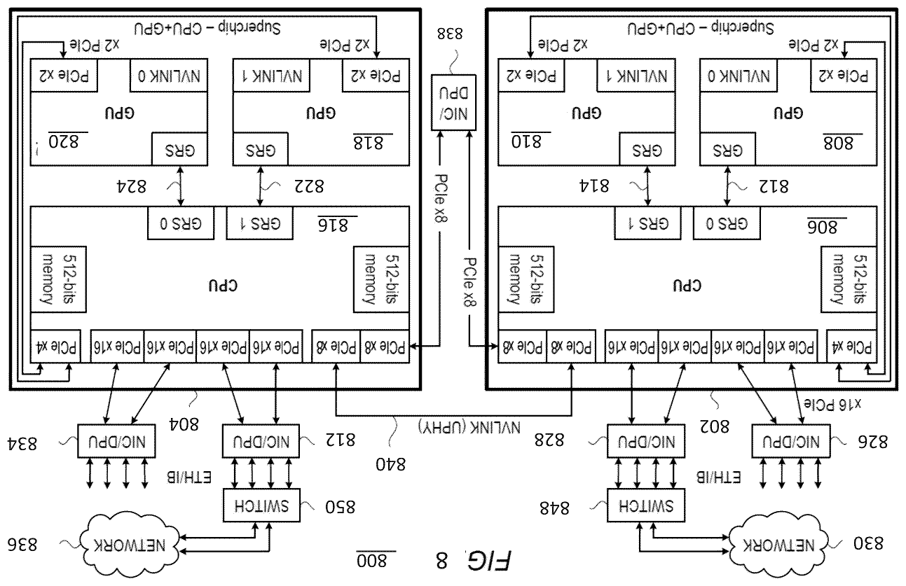

Reference is now made to FIGS. 6 and 7, which are port power graphs illustrating different configurations. FIG. 6 illustrates a port power graph 600 showing a configuration where all ports 46 of nodes 12 are active. The port power graph 600 depicts active periods 602 of port operation along a timeline indicated by arrow 604. FIG. 6 shows active periods 602 with intervals of 0.4 millisecond (ms) duration separated by 1 ms gaps of inactivity, with an L1 state period of 0.4 ms. The ports do not enter L1 immediately after an active period ceases due to exit latency of the L1 state. Therefore, the ports enter L1 state after 0.6 ms of inactivity leading to an L1 state period of 0.4 ms. In such a scenario, the ports are in L1 state for about 28% of the time. In the example of FIG. 6, the power level available for computing power by the nodes 12 is 1000 W.

FIG. 7 illustrates a port power graph 700 showing a configuration where a subset of ports 46 are active while the remaining ports 46 of nodes 12 are in a low power state, e.g., L1. FIG. 7 shows active periods 702 with intervals of 1.2 ms duration separated by 0.2 ms gaps of inactivity, with no L 1 state being achieved in the gap of inactivity. If half of the ports are active with conveying traffic and half of the ports do not convey traffic, but are in L1 state, then L1 state is achieved by 50% of the ports for the whole time period. The saved power may be transferred for use by the compute function of the nodes 12, leading to a power level available for computing power by the nodes 12 equal to 1100 W.

The comparison between the port power graphs 600 and 700 highlight the power savings that may be achieved through selective port activation. In the configuration shown in the port power graph 700, unused ports may enter a low-power state, potentially reducing overall power consumption or providing saved power to compute functionality.

In some cases, orchestrator 20 may reallocate power saved from unused ports entering the low-power state to node compute resources. This reallocation may allow for increased computational capacity or improved performance in other areas of the nodes, potentially offsetting any performance impact from the reduced number of active ports.

The port power graphs 600 and 700 may illustrate how selective routing and port activation can lead to more efficient power utilization in a node interconnect network. By allowing unused ports to enter a low-power state, the system may achieve power savings while maintaining necessary network connectivity and potentially improving overall system performance through power reallocation.

In some cases, the system for managing power consumption in a node interconnect network may be implemented with alternative network topologies. For example, the network may utilize a fat tree topology, a torus topology, or a dragonfly topology instead of the mesh-like topology described previously. These alternative topologies may offer different trade-offs in terms of scalability, latency, and bandwidth that may be advantageous for certain applications or workloads.

While the system has been primarily described in the context of GPU-based computing systems, the power management techniques may be applied to other types of node interconnect networks. For example, the system may be implemented in high-performance computing clusters composed of CPUs, field-programmable gate arrays (FPGAs), or application-specific integrated circuits (ASICs). The principles of selectively routing traffic to subsets of available ports to allow unused ports to enter low-power states may be applicable across various computing architectures.

In some cases, the granularity of power management may be adjusted. Rather than managing power at the port level, the system may operate at a finer granularity, such as individual lanes within a port. This may allow for more precise control over power consumption in scenarios where partial port utilization is common.

The system may incorporate machine learning techniques to optimize routing profiles. By analyzing historical traffic patterns and system performance metrics, machine learning models may predict future network usage and proactively adjust routing profiles to maximize power efficiency while maintaining performance targets.

The power management techniques described may be applied to other types of interconnects beyond node-to-node communication networks. For example, similar principles may be used to manage power consumption in storage area networks or in-memory interconnects within individual compute nodes.

In some implementations, the system may support heterogeneous networks where different types of links with varying power characteristics coexist. The routing profiles and power management strategies may be tailored to account for these differences, potentially prioritizing the use of more power-efficient links when possible.

Reference is now made to FIG. 8, which is a block diagram that schematically illustrates a computing system 800, e.g., a data center or a High-Performance Computing (HPC) cluster, in accordance with an embodiment of the present disclosure.

System 800 comprises a plurality of subsystems, e.g., multiple processing devices coupled to each other, multiple network devices, and multiple networks, according to at least one embodiment. Computing system 800 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 800 and to one or more external networks 830, 836. In the present example, system 800 comprises a packet switch 848 that connects NIC/DPU 828 to network 830, and a packet switch 850 that connects NIC/DPU 832 to network 836.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs.

FIG. 8 also demonstrates an example architecture of a multi-GPU architecture. As illustrated in the figure, computing system 800 includes a processing device 802 with a multi-GPU architecture. In particular, processing device 802 may be a system-on-chip and includes multiple subsystems such as a CPU 806, a GPU 808, and a GPU 810. CPU 806 can be coupled to GPU 808 via a die-to-die (D2D) or chip-to-chip (C2C) interconnect 812, such as a Ground-Referenced Signaling interconnect (GRS interconnect). CPU 806 can be coupled to GPU 810 via a D2D or C2C interconnect 814. CPU 806 can also couple to GPU 808 and GPU 810 via PCIe interconnects.

CPU 806 can be coupled to one or more NICs or DPUs, which are coupled to one or more networks. For example, as illustrated in FIG. 8, CPU 806 is coupled to a first NIC/DPU 826, which is coupled to a network 830. CPU 806 is also coupled to a second NIC/DPU 828, which is coupled to network 830 via switch 848. NIC/DPU 826 and NIC/DPU 828 can be coupled to network 830 over Ethernet (ETH), NVLINK or InfiniBand (IB) connections, for example.

Computing system 800 also includes a processing device 804 with a multi-GPU architecture. In particular, processing device 804 includes multiple subsystems including a CPU 816, a GPU 818, and a GPU 820. CPU 816 can be coupled to GPU 818 via a D2D or C2C interconnect 822. CPU 816 can be coupled to GPU 820 via a D2D or C2C interconnect 824. CPU 816 can also couple to GPU 818 and GPU 820 via PCIe interconnects. CPU 816 can be coupled to one or more NICs or DPUs, which are coupled to one or more networks. For example, as illustrated in FIG. 8, CPU 816 is coupled to a first NIC/DPU 832, which is coupled to a network 836. CPU 816 is also coupled to a second NIC/DPU 834, which is coupled to network 836 via switch 850. NIC/DPU 832 and NIC/DPU 834 can be coupled to network 836 over Ethernet (ETH), NVLINK or InfiniBand (IB) connections.

In at least one embodiment, processing device 802 and processing device 804 can communicate with each other via a NIC/DPU 838, such as over PCIe interconnects. Processing device 802 and processing device 804 can also communicate with each other over a high-bandwidth communication interconnect 840, such as an NVLink interconnect or other high-speed interconnects. The packet switches in FIG. 8 may comprise, for example, Nvidia Quantum-2 switches. The NICs/DPUs in the figure may comprise, for example, Nvidia Bluefield DPUs.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system for managing power consumption in a node interconnect network, comprising:
a plurality of nodes interconnected via a network; and
an orchestrator to:
analyze link requirements;
configure dynamic routing profiles for the plurality of nodes based on the link requirements; and
instruct the plurality of nodes to implement the dynamic routing profiles, wherein each one node of the plurality of nodes is to selectively route traffic to a subset of available ports of the one node based on a dynamic routing profile of the one node, thereby allowing unused ports to enter a low-power state.

2. The system according to claim 1, wherein the orchestrator is to monitor network traffic and adjust the dynamic routing profiles in real-time based on changes in the monitored network traffic.

3. The system according to claim 1, wherein the low-power state is an L1 state.

4. The system according to claim 1, wherein each one node comprises a routing device to implement the dynamic routing profile for the one node.

5. The system according to claim 4, wherein the routing device is to route traffic defined as critical traffic to the available ports and traffic defined as non-critical traffic to the subset of the available ports.

6. The system according to claim 1, wherein the orchestrator is to reallocate power saved from unused ports entering the low-power state to node compute resources.

7. The system according to claim 1, wherein the node is a graphics processing unit (GPU) or a central processing unit (CPU).

8. An orchestrator for managing power consumption in a node interconnect network, comprising:
a processor to:
analyze link requirements in a network interconnecting a plurality of nodes;
configure dynamic routing profiles for the plurality of nodes based on the link requirements; and
instruct the plurality of nodes to implement the dynamic routing profiles, wherein the dynamic routing profiles cause each node to selectively route traffic to a subset of available ports, thereby allowing unused ports to enter a low-power state; and
an interface to share data with the nodes.

9. The orchestrator according to claim 8, wherein the processor is to monitor network traffic and adjust the dynamic routing profiles in real-time based on changes in the monitored network traffic.

10. The orchestrator according to claim 8, wherein the low-power state is an L1 state.

11. The orchestrator according to claim 8, wherein the processor is to instruct each node to route traffic defined as critical traffic to all the available ports and traffic defined as non-critical traffic to the subset of the available ports.

12. The orchestrator according to claim 8, wherein the processor is to reallocate power saved from unused ports entering the low-power state to node compute resources.

13. The orchestrator according to claim 8, wherein the node is a graphics processing unit (GPU) or a central processing unit (CPU).

14. A node device, comprising:
a plurality of ports to connect to links of a network;
a routing device to route network traffic to the plurality of ports; and
a processor to configure the routing device to selectively route traffic to a subset of the plurality of ports, thereby allowing unused ports to enter a low-power state.

15. The node device according to claim 14, wherein the processor is to receive a dynamic routing profile from an orchestrator.

16. The node device according to claim 15, wherein the processor is to configure the routing device based on the received dynamic routing profile.

17. The node device according to claim 14, wherein the low-power state is an L1 state.

18. The node device according to claim 14, wherein the routing device is to route traffic defined as critical traffic to all of the plurality of ports and traffic defined as non-critical traffic to the subset of the plurality of ports.

19. The node device according to claim 14, wherein the processor is to:
monitor network traffic on the plurality of ports; and
send network traffic data to an orchestrator.

20. The node device according to claim 19, wherein the processor is to receive an updated dynamic routing profile from the orchestrator based on the sent network traffic data.

21. The node device according to claim 20, wherein the processor is to reconfigure the routing device based on the updated dynamic routing profile to adjust the subset of the plurality of ports to which traffic is selectively routed.

22. The node device according to claim 14, wherein the node device is a graphics processing unit (GPU) or a central processing unit (CPU).
